(19) United States
(12) Patent Application Publication
(10) Pub. No.: US 2023/0100500 A1
(43) Pub. Date: Mar. 30, 2023

(54) GAMING MACHINE AND METHOD WITH MULTIPLE GAME MODES

(71) Applicant: Everi Games Inc., Austin, TX (US)

(72) Inventors: Juan Carlos Mariscal, Lincolnwood, IL (US); Rodrigo Barso Soliva, Mundelein, IL (US); Scott Donald Slomiany, Rolling Meadows, IL (US)

(73) Assignee: Everi Games Inc., Austin, TX (US)

(21) Appl. No.: 17/953,218

(22) Filed: Sep. 26, 2022

Related U.S. Application Data
(60) Provisional application No. 63/250,927, filed on Sep. 30, 2021.

(51) Int. Cl. G07F 17/32

(52) U.S. Cl. CPC G07F 17/3227; G07F 17/3267; G07F 17/3262; G07F 17/3244; G07F 17/3213; G07F 17/3209

(57) ABSTRACT

A group of gaming machines, method, and program product are provided for operating in two gaming modes. In response to a mode change event received over the network, the mode of gaming machines in the group changes from a first gaming mode to a second gaming mode including a meter displayed by the display system and a different paytable for the game than the first gaming mode. A level of the respective meter for each gaming machine in the group is reduced based on the time spent in the second gaming mode. A bonus event trigger activates a bonus feature for the respective gaming machine including at least one bonus prize, and in response to the bonus outcome at the respective gaming machine, meter level is decreased at each gaming machine in the group. The second game mode ends when the meter reaches a defined lowest level.

### CROSS-REFERENCE TO RELATED APPLICATION

Applicant claims the benefit, under 35 U.S.C. § 119(e), of U.S. Provisional Patent Application No. 63/250,927 filed Sep. 30, 2021, and entitled “Gaming Machine and Method with Multiple Game Modes.” The entire content of this provisional application is incorporated herein by this reference.

### COPYRIGHT NOTICE

A portion of the disclosure of this patent document contains material subject to copyright protection. The copyright owner has no objection to the facsimile reproduction of the patent document or the patent disclosure as it appears in the U.S. Patent and Trademark Office patent files or records, but otherwise reserves all rights.

### FIELD OF THE INVENTION

This invention relates to gaming systems and to gaming machines through which players may participate in wagering games, and in particular gaming machines including games with multiple gaming modes.

### BACKGROUND

Many different types of gaming machines have been developed to provide various formats and graphic presentations for conducting games and presenting game results. For example, numerous mechanical reel-type gaming machines, also known as slot machines, have been developed with different reel configurations, reel symbols, and paylines. More recently, gaming machines have been developed with video monitors that are used to produce simulations of mechanical spinning reels. These video-based gaming machines may use one or more video monitors to provide a wide variety of graphic effects in addition to simulated spinning reels, and may also provide secondary/bonus games using different reel arrangements or entirely different graphics. Many video-based gaming machines have three or five spinning reels that may be stopped to display a matrix of game symbols. The symbols displayed on the stopped reels correlate to a result of the game. Video-based gaming machines may also be used to show card games or various types of competitions such as simulated sporting competitions on which wagers may be placed. A popular use of wagering games is simulated wagering in which money is never involved, and instead points or simulated currency are wagered. Many “virtual casino” websites and smartphone apps employ such a scheme in addition to or instead of money wagering.

A typical reel-based slot machine game includes a number of paylines defined through symbol locations on a reel. Numerous variations are used to improve the prize variability and player enjoyment associated with such payline games. However, game manufacturers are continuously pressed to develop new game presentations, formats, and game graphics in an attempt to provide high entertainment value for players and thereby attract and keep players.

### SUMMARY OF THE INVENTION

The present invention encompasses methods for controlling wagering games, gaming machines, and computer programs that provide multiple gaming modes are coordinated with graphic presentations to vary the playing experience.

A gaming machine, system, method, and program product provide a slot machine game with a primary base game mode and a secondary mode. The secondary mode, when activated for a group of gaming machines, continues until a meter appearing on each gaming machine in the second game mode is depleted.

According to one aspect of the invention, a method is provided for controlling the operation of a group of gaming machines linked on a network. The method includes, in response to a play input entered through a player input device of a respective one of the gaming machines and under control of a processing system of the respective gaming machine, causing a display system of the respective gaming machine to display a base result representation in a first area of the display system including a matrix of symbol locations in a first gaming mode. In response to a mode change event received over the network, the method changes the mode of all gaming machines in the group to a second gaming mode including a meter displayed by the display system and a different paytable for the game than that of the first gaming mode, receives play inputs in the second gaming mode, provides results therefore, and decreases a level of the respective meter for each gaming machine in the group based on the time spent in the second gaming mode. In response to a gaming result at the respective gaming machine including a bonus event trigger in the second gaming mode, the method activates a bonus outcome for the respective gaming machine including at least one bonus prize, and in response to the bonus outcome at the respective gaming machine, decreases the level of the meter at each gaming machine in the group. The method ends the second game mode and returns to the first game mode for each gaming machine in the group when the meter reaches a defined lowest level.

According to some implementations of the first aspect, the mode change event is determined by a group control server based on randomly selecting a time to change the mode from the first mode to the second mode.

In some implementations, decreasing a level of the respective meter for each gaming machine in the group based on the time spent in the second gaming mode is done continuously at a designated rate over the time spent in the second game mode, and decreasing the level of the meter at each gaming machine in the group in response to the bonus outcome at the respective gaming machine further includes reducing the meter at a higher rate than the designated rate over a period during which the bonus outcome is presented at the respective gaming machine. The designated rate may be a rate that depletes the meter to the defined lowest level over more than five minutes, and decreasing the level of the meter at each gaming machine in the group in response to the bonus outcome at the respective gaming machine further may include decreasing the meter by at least 10% in the period during which the bonus outcome is presented.

In some implementations, at least one of the designated rate or the higher rate is adjusted depending on the number of players active at the group of gaming machines.

The meter may include a graphic presentation of a fuel gauge, where decreasing the level of the meter at each gaming machine in the group in response to the bonus outcome at the respective gaming machine further includes multiple phases each presenting a graphical sequence depicting fuel being burned in a graphic presentation of the bonus outcome, each phase with an associated depletion of the fuel gauge.

According to some implementations, the bonus outcome provides the at least one bonus prize only for the respective gaming machine, and in which the second gaming mode further includes in response to a gaming result at a second respective gaming machine of the group of gaming machines including a bonus event trigger, activating a bonus outcome for the second respective gaming machine including at least one bonus prize, and in response to the bonus outcome at the second respective gaming machine, decreasing the level of the meter at each gaming machine in the group.

Another aspect of the invention is a system including a group of gaming machines and a group control server. Each gaming machine including a display system, an audio device, a player input device, and at least one electronic controller operatively coupled to the display system, the audio device and the player input device and configured to execute instructions to perform the method. A tangible, non-transitory electronically accessible memory is connected to the at least one electronic controller and contains program code executable by the at least one electronic controller for performing the method in coordination with the group control server.

Another aspect of the invention is a computer program stored on one or more non-transitory computer readable medium. The software version is, of course, typically designed to be executed by a gaming machine or networked gaming system. The software includes multiple portions of computer executable code referred to as program code. Gaming results are provided in response to activations and displayed by display program code that generates simulated slot reels each including one or more symbol locations. The program also has game controller program code for determining game play results involving operating the gaming machine according to the methods above.

Another aspect of the invention is a gaming system that includes one or more gaming servers, and a group of electronic gaming machines connected to the servers by a network, programmed to provide one of more of the methods described herein. The various functionality described herein may be distributed between the electronic gaming machines and the gaming servers in any practically functional way. For example, the current preferred architecture is for the servers to determine all aspects of game logic, random number generation, and prize awards. The gaming machines provide functionality of interfacing with the player and animating the game results to present the results received from the server in an entertaining manner. However, other embodiments of course might use a thin client architecture in which the animation is also conducted by the server and electronic gaming machines serve merely as a terminal to receive button or touchscreen input from the player and to display graphics received from the server.

Different features may be included in different versions of the invention. These and other advantages and features of the invention will be apparent from the following description of the preferred embodiments, considered along with the accompanying drawings.

### BRIEF DESCRIPTION OF THE DRAWINGS

FIG. 1 is a game screen diagram illustrating a base game mode showing a primary display to illustrate an example slot machine display arrangement on which wagering game results are presented in a primary display area according to some embodiments.

FIG. 2 shows a sequence of game screen diagrams depicting a respin feature available in the base game mode of FIG. 1.

FIGS. 3-7 show a sequence of game screen diagrams of a second gaming mode according to some embodiments.

FIG. 8 is a flow diagram of a process of operating a group of gaming machine to change modes and operate the second gaming mode according to some embodiments.

FIG. 9 shows a flow diagram of a process for controlling the group of gaming machines to conduct a bonus sequence according to some embodiments.

FIG. 10 shows a gaming machine that may be used to implement feature games according to some embodiments.

FIG. 11 is a block diagram showing various electronic components of the gaming machine shown in FIG. 10 together with additional gaming system components.

FIG. 12 is a system block diagram of a gaming system according to one embodiment.

### DETAILED DESCRIPTION OF EXAMPLE EMBODIMENTS

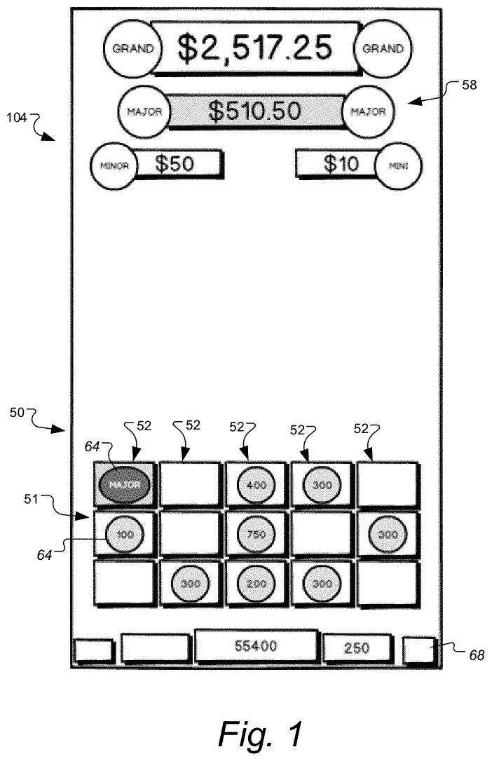

FIG. 1 is a game screen diagram illustrating a first base game mode showing a primary display 104 to illustrate an example slot machine display arrangement on which wagering game results are presented in a primary display area 50, typically found on the primary display. A secondary display area 58 is present on the display 104, typically located toward the top of the display. In versions including multiple displays, secondary display area 58 may be located on a secondary, upper display.

The primary display area 50 in the depicted mode presents a reel-type primary game (as opposed to bonus games or other feature games as described herein), which in this version includes a matrix 51 of symbol locations 54 arranged in rows and columns to represent simulated slot machine reels that are spun to conduct a game round. Other embodiments may, of course, use other types of game displays to display randomizing of symbols according to the methods herein. The depicted columns 52 of symbol locations represent the simulated reels, while symbols are shown in each symbol location designated 54. In this implementation there are five reels with three symbol locations 54 displayed at a time on each reel, but the game can be played with a different number and size of reels. The simulated reel typically has far more symbols than those displayed, and as many unique stop positions as there are symbols on the simulated reel. The stop position may be counted, for example, by numbering the symbols on the simulated reel and using the number of the symbol at the bottom of the display window (the three symbols displayed in this example), or at the top or middle. While columns are used herein, other lines of symbols such as rows may also be used to provide simulated reels or other symbol arrays that are filled with randomly selected symbols to produce game round results.

In this embodiment, secondary display area 58 shows progressive pries available to be won in the game, including a “GRAND” prize, a “MAJOR” prize, a “MINOR” prize, and a “MINI” prize. Other embodiments may instead include fixed bonus prizes presented in the same manner. Other touchscreen buttons for configuring the bet and activating play in the game, such as a play button 68, may be present in primary display area 50.

Winning patterns are formed by matching symbols along defined paylines that pass through the matrix 51. In some embodiments, a bonus symbol 64 has a possibility of appearing in one or more of columns 52. The progressive prizes are won in the game by the appearance of a scatter pattern of multiple symbols associated with the jackpot, such as the “MAJOR” symbol depicted in FIG. 1.

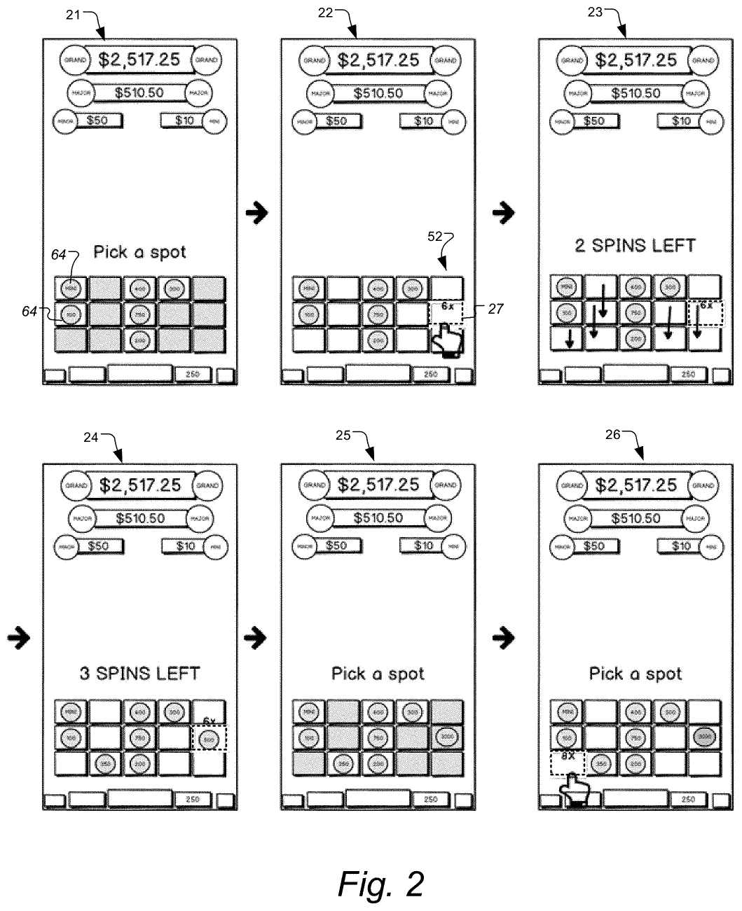

FIG. 2 shows a sequence of game screen diagrams depicting a respin feature available in the base game mode of FIG. 1. In this implementation, the respin feature is triggered by the appearance of a scatter pattern of a designated number, such as three or more, of bonus symbols 64 having prizes indicated on them by showing either numerical prize amounts, names of the progressive prizes, or other indications of the progressive prizes. For example, game screen diagram 21 shows such a scatter pattern of six bonus symbols 64.

The respin feature next prompts the player to select a symbol location from among those locations not occupied by the scatter pattern. Game screen diagram 22 depicts a player selecting a location on the right-hand column 52. The selection preferably made through the touch screen interface of the gaming machine, as indicated by the hand symbol shown selecting a symbol location 27, and reveals a multiplier value such as the depicted “6×” value for use in the respin feature. Next, as shown in game screen diagram 23, a free respin is conducted to randomize the symbols of the array, as indicated by the movement arrows. The symbol locations included in the respin are all the locations in the array except for those containing the scatter pattern, which are frozen for the duration of the respin feature. The number of available spins may increase during the respin feature.

As shown at game screen diagram 24, any numerical prize symbol that appears on the selected location has the multiplier applied to the prize thereon, and the prize is awarded. Such prize symbols are then frozen for the remainder of the respins. After the respin, the player is again prompted to select a location as depicted by game screen diagrams 25 and 26, which show a player selecting another location and revealing a multiplier value of “8×”. Such selections continue until the respin round ends.

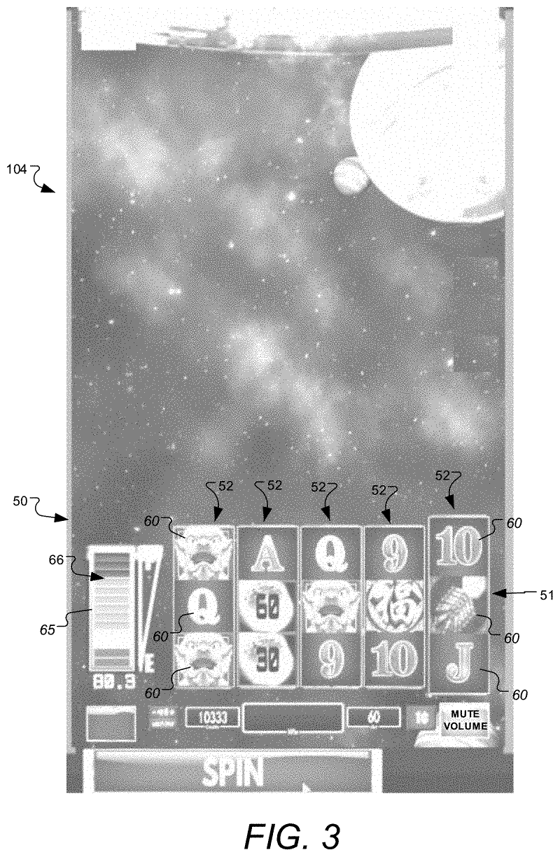

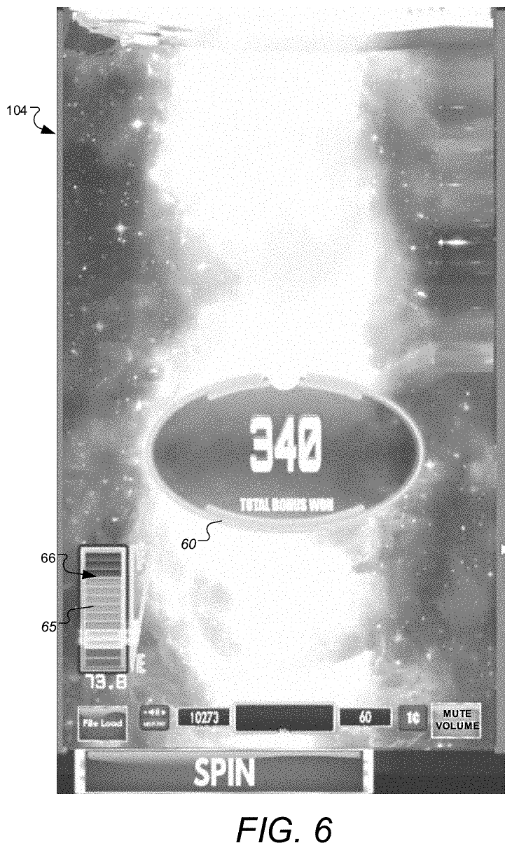

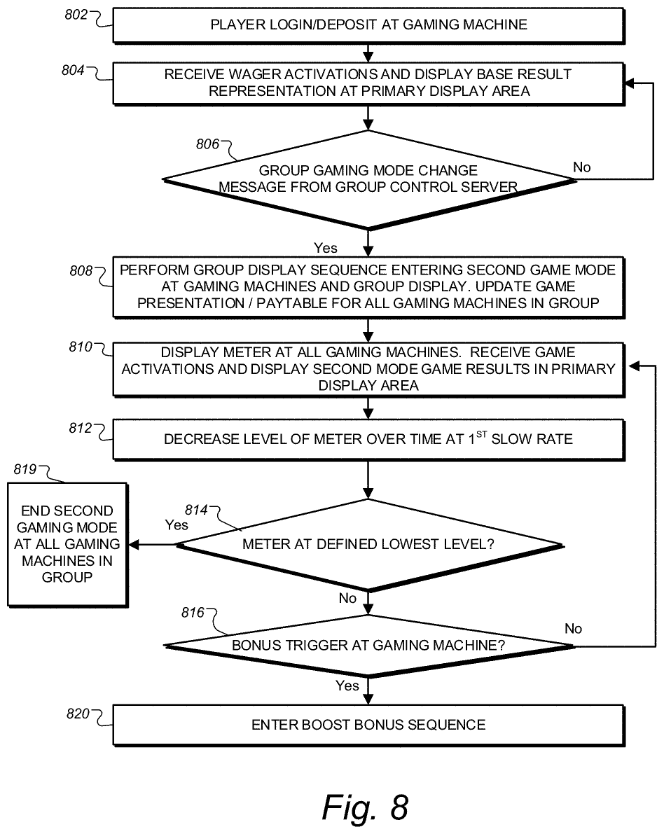

FIGS. 3-7 show a sequence of game screen diagrams of a second gaming mode according to some embodiments. This sequence of figures is used to illustrate an example process as shown in FIG. 8.

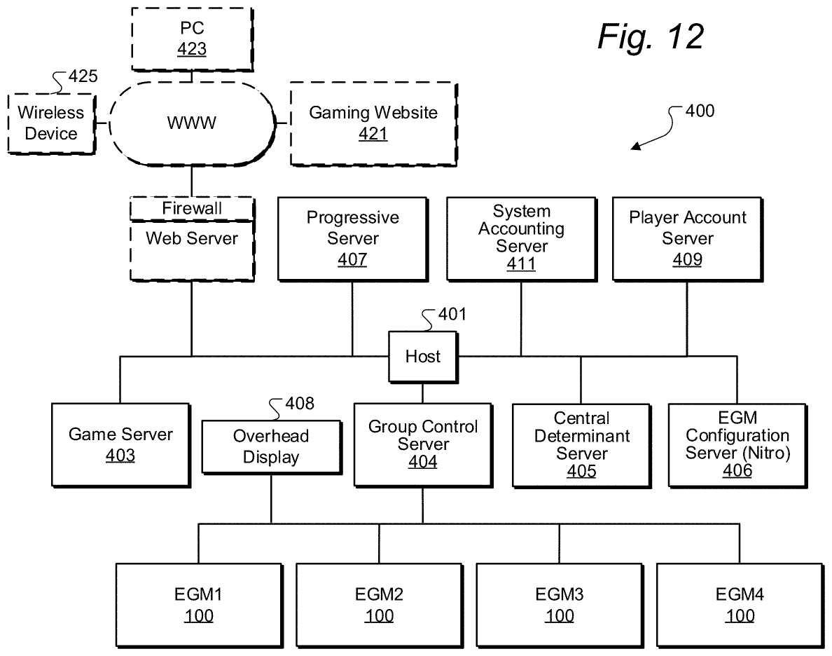

FIG. 8 is a flow diagram of a process of operating a group of gaming machine to change modes and operate the second gaming mode according to some embodiments. The group of gaming machines is preferably plurality of gaming machines such as EGM1-EGM4 (FIG. 12) arranged side-by-side with an overhead group display (408, FIG. 12) positioned over the gaming machines. The number of gaming machines in the group may be small, for example two or three, or a large number such as 20 gaming machines. The machines enter the second gaming mode together and certain feature of the second gaming mode are applied common to all gaming machines in the group, as further described below.

Generally, the process is performed responsive to play activation inputs entered through player input devices of the gaming machines and under control of processing system of the gaming machines. The process beings at block 802 where a player logs into a gaming machine or makes a credit deposit to establish a credit balance at the gaming machine. This includes receiving the player deposit through a credit input device such as a bill/voucher acceptor, and in response activating a credit meter value that establishes a player credit balance.

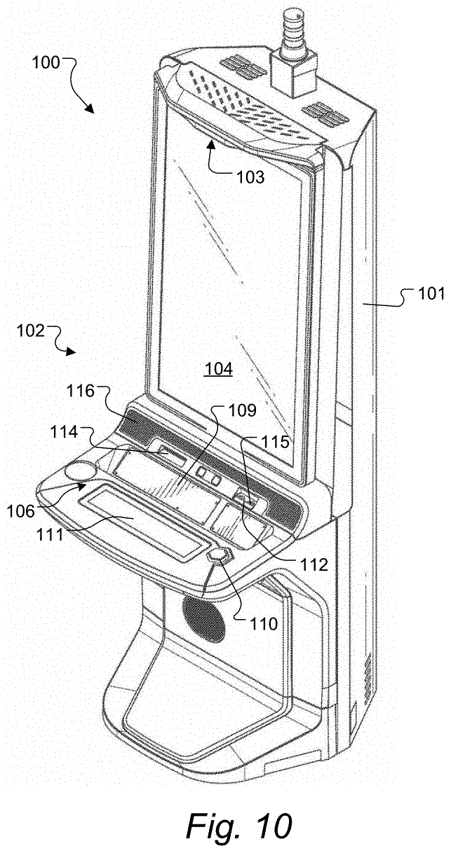

To begin a game play, at block 804 the process receives a wager activation on a player input device at the gaming machine, which typically consists of some input from the player to set the amount to be wagered from their credit amount on the machine and activate a game round using the set wager amount. The wager amount may also be carried over from previous game rounds by simply starting the game with the previous wager amount set. This typically happens through a ‘Play’ button on the game cabinet (110, FIG. 10) or touchscreen display (68, FIG. 1), and serves to place the wager and start a single round of game play in the base game. The game round includes randomly selecting symbols to populate matrix 51 and displaying matrix 51 being updated to include the selected symbols as depicted, for example, in the embodiment of FIG. 1.

The process continues in the first game mode until a game mode change occurs at block 806, as depicted by the return from block 806 to block 804. While a linear flow diagram is shown to explain the game, the actual operation is preferably implemented with event driven logic. At block 806, in response to a mode change event received over a gaming network, the process goes to block 808 where it changes the mode of the gaming machines in the group to a second gaming mode including a meter displayed by the display system. The updated presentation may include a different set of symbols than those of the first gaming mode. The updated presentation may also include a different paytable for the game than that of the first gaming mode. A group control server (404, FIG. 12) in this embodiment is adapted to communicate with the gaming machines over the network and operates to control the change of mode from the first gaming mode to the second gaming mode based on randomly selecting a time to change the mode from the first mode to the second mode.

The mode change at block 808 in this embodiment includes performing multimedia sequence on the gaming machines in the group and the group display.

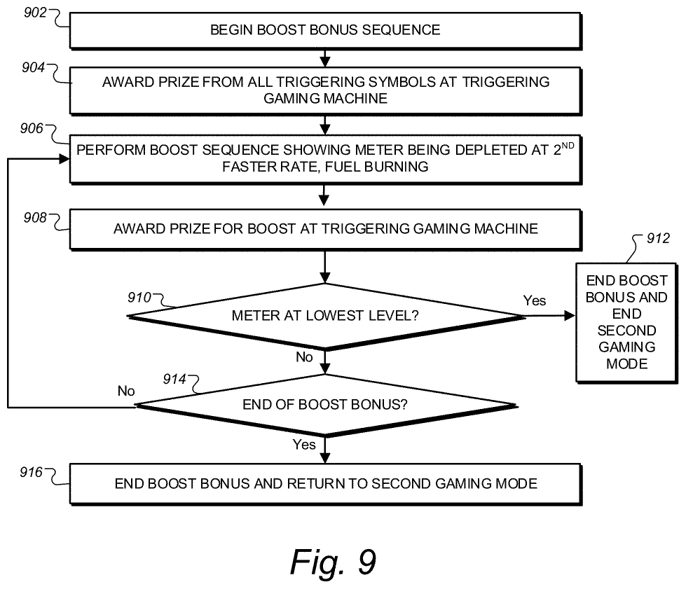

As shown at block 810, in the second gaming mode the process displays a meter 65 (FIG. 3) at the primary display area of each of the group of gaming machines. Meter 65 includes a level indicator 66 showing a level of the meter, which begins the second gaming mode at a full level and decreases over the course of the second gaming mode toward a lowest level. In the second gaming mode at block 810, the process includes receiving play inputs activating wagers and game plays, providing results therefore, and decreasing a level of the meter based on the time spent in the second gaming mode as shown at block 812. In this embodiment, the meter decreases at a first slow rate such as a rate that would deplete the meter to the lowest level in a time period on the order of minutes, such as five minutes or ten minutes. When the group of gaming machines is more highly occupied with more players active in the group, the process at block 812 may include adjusting the first slow rate to a lower rate such that the larger number of active players depletes the meter more slowly than they would at the original second decay rate due to bonus activations depleting the meter (FIG. 9).

As shown at block 814, when the meter reaches the defined lowest level, the process goes to block 819 where it ends the second gaming mode for all gaming machines in the group, and returns them to the first gaming mode.

At block 816, responsive to a bonus event trigger at one of the gaming machines in the second gaming mode, the process goes to block 820 where it begins a bonus feature called the “boost bonus” in this embodiment. This bonus feature, an example of which is depicted in FIG. 9, includes activating a bonus outcome for the gaming machine including at least one bonus prize, and in response to the bonus outcome at the gaming machine, decreasing the level of the meter at all of the gaming machines in the group.

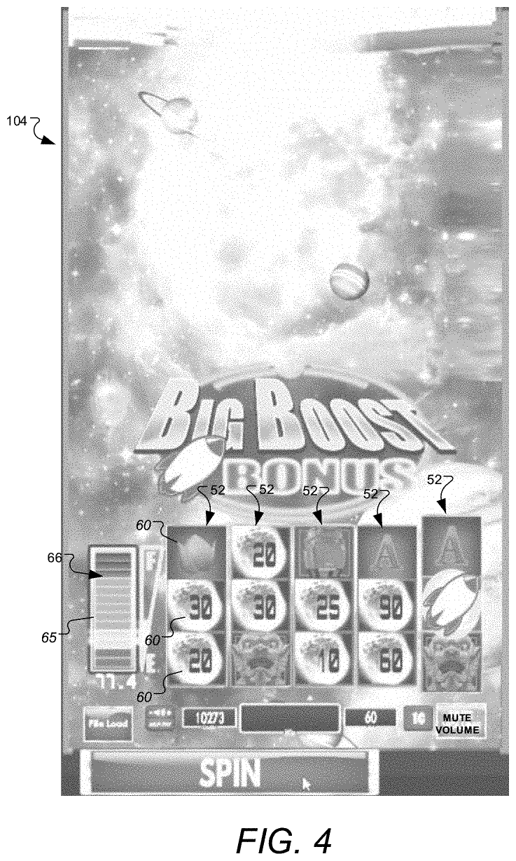

FIG. 9 shows a flow diagram of a process for controlling the group of gaming machines to conduct a bonus sequence according to some embodiments. The process begins a bonus sequence, for example the “boost bonus” sequence when triggered such as by the trigger at 816 (FIG. 8). In the embodiment depicted in FIG. 4 through FIG. 7, the bonus triggering event in the second gaming mode is the appearance of a scatter pattern of at least a designated number prize symbols each having an associated prize depicted thereon, as shown in FIG. 4 by the eight “comet” prize symbols 60 having prize amounts depicted thereon such as “30” and “20”.

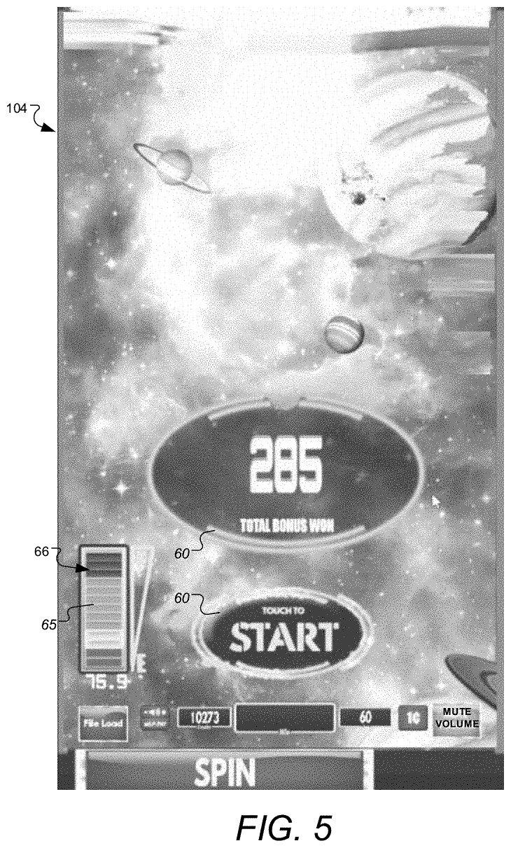

At block 904, the process awards the prize shown on all the symbols in the scatter pattern to the gaming machine in the group on which the scatter pattern appeared. This award is depicted in FIG. 5 where the total of the prize symbol prizes from FIG. 4, 285 credits, is awarded. A prompt such as the “TOUCH TO START” prompt may be included at block 904 at the triggering gaming machine to begin the remainder of the bonus feature.

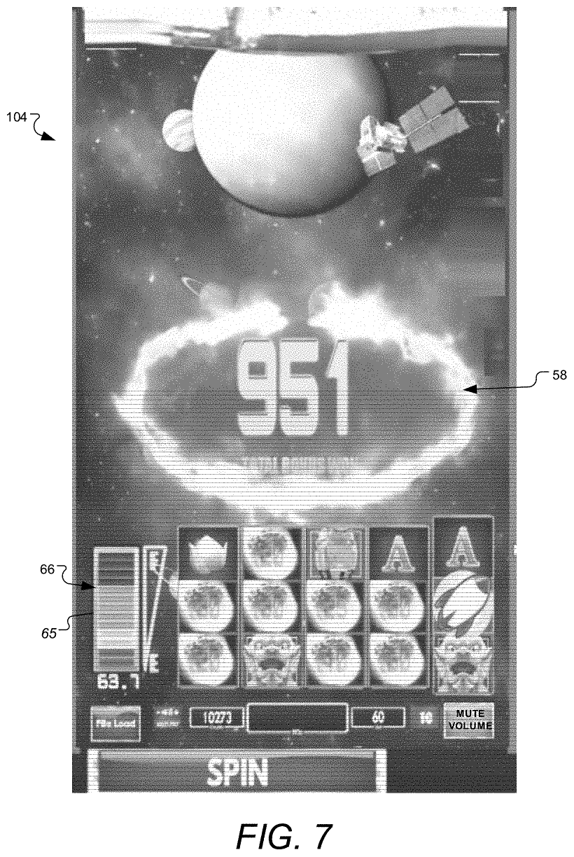

At block 906, the process includes performing a “boost” graphic bonus sequence in which decreasing the level of the meter at each gaming machine in the group in response to the bonus outcome at the respective gaming machine includes reducing the meter at a second faster rate than the first slow rate over a period during which the bonus outcome is presented at the respective gaming machine. A diagram of such a sequence in process is shown in FIG. 7, where the level 66 of meter 65 is shown being reduced as secondary display area 58 shows bonus credits being awarded to the gaming machine that triggered the bonus sequence. The second faster rate is preferably faster than the first slow rate by at least 100%, 200%, or 300%, and in preferred embodiments results in decreasing the meter by at least 10% or 15% in the period during which the bonus outcome is presented.

In this example of FIG. 7, the meter 65 includes a graphic presentation of a fuel gauge, and decreasing the level 66 of the meter at each gaming machine in the group in response to the bonus outcome at the gaming machine further includes multiple phases each presenting a graphical sequence depicting fuel being burned in a graphic presentation of the bonus outcome, each phase with an associated depletion of the fuel gauge. The prize achieved for the boost sequence at block 906 is awarded to the triggering gaming machine at block 908. Such an award may be made in multiple phases each showing visible increase in the meter depletion rate and fuel being burned through some graphic depiction (in this example, the exhaust of a rocket engine increasing in intensity for each boost phase). When the group of gaming machines is more highly occupied with more players active in the group, the process at block 906 may include adjusting the second decay rate to a lower rate such that the larger number of active players depletes the meter more slowly than they would at the original second decay rate.

If the meter reaches the lowest defined level at the end of the bonus sequence, the process at block 910 goes to block 912 where it ends the bonus presentation and ends the second gaming mode, returning to the first gaming mode. The process randomly selects a number of phases to provide a randomly selected total prize for the bonus feature. As shown at block 914, if more phases are available, the process returns to block 906 where it continues the bonus feature by performing additional “boost” sequences that deplete meter 65. Once the final boost sequence is complete, the process at block 914 goes to block 916 where it ends the bonus feature and returns to the second gaming mode.

The meter level is common to all gaming machines in the group, and therefore the players at gaming machines that did not trigger a particular bonus feature are affected by the bonus feature in that each time another machine triggers the bonus feature, their time in the second gaming mode is reduced by the accelerated meter depletion of the bonus feature. In the second gaming mode, all the machines in the group are eligible to trigger the bonus feature, and over the typical duration of the second gaming mode of several minutes, multiple different machines in the group will typically trigger the bonus mode. Each triggered bonus mode follows the process of FIG. 9. For example, in response to a gaming result at a second respective gaming machine of the group of gaming machines including a bonus event trigger, the process of FIG. 9 includes activating a bonus outcome for the second respective gaming machine including at least one bonus prize, and in response to the bonus outcome at the second respective gaming machine, decreasing the level of the meter at each gaming machine in the group.

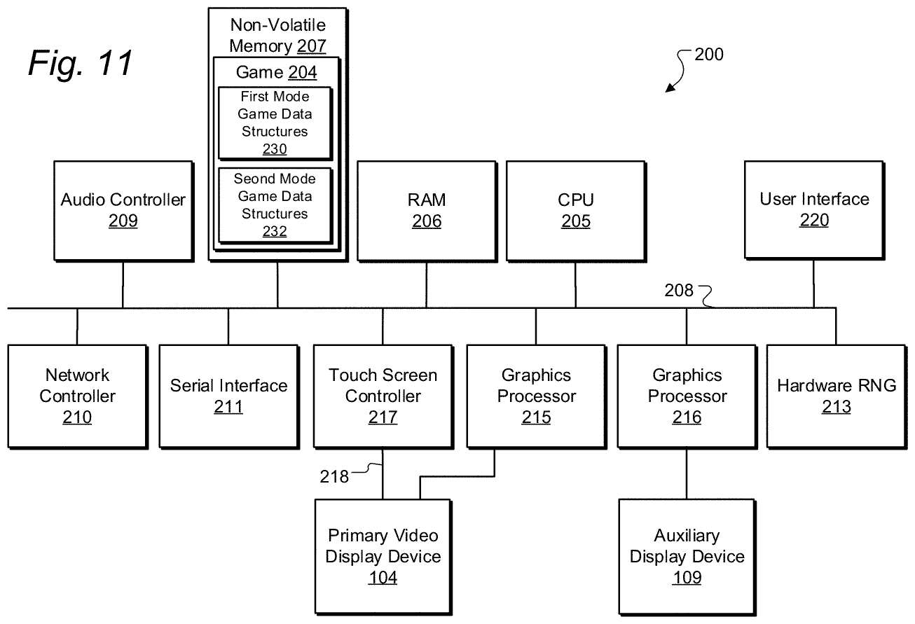

FIG. 10 shows a gaming machine 100 that may be used to implement feature games according to the present invention. The block diagram of FIG. 11 shows further details of gaming machine 100. Referring to FIG. 10, gaming machine 100 includes a cabinet 101 having a front side generally shown at reference numeral 102. Gaming machine 100 includes a display system including one or more display devices such as video displays or mechanical display devices such as spinnable reels or wheels. In the depicted version, the display system includes a primary video display device 104 which is mounted in a central portion of the front side 102, with a ledge 106 positioned below the primary video display device and projecting forwardly from the plane of the primary video display device. Gaming machine 100 also includes two additional smaller auxiliary display devices, and a lower auxiliary display device 109. All of the displays may include touchscreen sensors, especially auxiliary display device 109 which may be used to present touchscreen controls for wagering. It should also be noted that each display device referenced herein may include any suitable display device including a cathode ray tube, liquid crystal display, plasma display, LED display, or any other type of display device currently known or that may be developed in the future.

In preferred versions, the gaming machine 100 illustrated in FIG. 10 also includes a number of mechanical control buttons 110 mounted on ledge 106. These control buttons 110 may allow a player to select a bet level, select paylines, select a type of game or game feature, and activate a play in the primary game. Further, primary video display device 104 in gaming machine 100 provides a convenient display device for implementing touchscreen controls.

Gaming machine 100 may also include a number of other player interface devices in addition to devices that are considered player controls for use in playing a particular game. Ledge 106 may also include a hardware special object including a button, touch sensor, or switches, joysticks, or other mechanical input devices, and/or virtual buttons and other controls implemented on a suitable touchscreen video display. Gaming machine 100 also includes a currency/voucher acceptor 112 having an input ramp, a player card reader having a player card input 114, and a voucher/receipt printer having a voucher/receipt output 115. One or more of these devices provides a credit input device in communication with the controller and adapted for accepting a physical item associated with a monetary value that establishes a player credit balance. Audio speakers 116 generate an audio output to enhance the user's playing experience. Numerous other types of devices may be included in gaming machines that may be used according to the present invention.

FIG. 11 shows a hardware and logical block diagram 200 of gaming machine 100 which includes a central processing unit (CPU) 205 along with random access memory 206 and nonvolatile memory or storage device 207. All of these devices are connected on a system bus 208 with an audio controller 209, a network controller 210, and a serial interface 211. A graphics processor 215 is also connected on system bus 208 and is connected to drive primary video display device 104 (mounted in cabinet 101 as shown in FIG. 10). A second graphics processor 216 is also connected on system bus 208 in this example to drive the auxiliary display device 109 also shown in FIG. 10. Gaming machine 100 also includes a touch screen controller 217 connected to system bus 208. Touch screen controller 217 is also connected via signal path 218 to receive signals from a touchscreen element associated with primary video display device 104. It will be appreciated that the touchscreen element itself typically comprises a thin film that is secured over the display surface of primary video display device 104. The touchscreen element itself is not illustrated or referenced separately in the figures.

Those familiar with data processing devices and systems will appreciate that other common electronic components will be included in gaming machine 100 such as a power supply, cooling systems for the various system components, audio amplifiers, and other devices that are common in gaming machines. These additional devices are omitted from the drawings so as not to obscure the present invention in unnecessary detail.

All of the elements 205, 206, 207, 208, 209, 210, and 211 shown in FIG. 11 are known elements used in the gaming machine industry. These elements are preferably mounted in a computer chassis which is housed in cabinet 101 shown in FIG. 10. Alternatively, the various electronic components may be mounted on one or more circuit boards or modules housed within cabinet 101 without a separate enclosure. Those familiar with data processing systems and the various data processing elements shown in FIG. 11 will appreciate that many variations on this illustrated structure may be used within the scope of the present invention. For example, since serial communications are commonly employed to communicate with a touch screen controller such as touch screen controller 217, the touch screen controller may not be connected on system bus 208, but instead include a serial communications line to serial interface 211, which may be a USB controller or a IEEE 1394 controller for example. It will also be appreciated that some of the devices shown in FIG. 11 as being connected directly on system bus 208 may in fact communicate with the other system components through a suitable expansion bus. Audio controller 209, for example, may be connected to the system via a PCI bus. System bus 208 is shown in FIG. 11 merely to indicate that the various components are connected in some fashion for communication with game processor/CPU 205 and is not intended to limit the invention to any particular bus architecture. Numerous other variations in the gaming machine internal structure and system may be used without departing from the principles of the present invention.

Although separate graphics processor 215 is shown for controlling primary video display device 104, and graphics processor 216 is shown for controlling both auxiliary display device 109, it will be appreciated that game processor/CPU 205 may control all of the display devices directly without any intermediate graphics processor. The invention is not limited to any particular arrangement of processing devices for controlling the video display device included with gaming machine 100. Also, a gaming machine implementing the present invention is not limited to any particular number of video display devices or other types of display devices.

In the illustrated gaming machine 100, game processor/CPU 205 executes software which ultimately controls the entire gaming machine including the receipt of player inputs and the presentation of the graphic symbols displayed according to the invention through the display devices 104 and 109 associated with the gaming machine. As will be discussed further below, game processor/CPU 205 either alone or in combination with graphics processor 215 may implement a presentation controller for performing functions associated with a primary game that may be available through the gaming machine, and may also implement a game client for directing one or more display devices at the gaming machine to display the feature game mode according to the present invention. Game processor/CPU 205 also executes software related to communications handled through network controller 210, and software related to various peripheral devices such as those connected to the system through audio controller 209, serial interface 211, and touch screen controller 217. Game processor/CPU 205 may also execute software to perform accounting functions associated with game play. Random access memory 206 provides memory for use by game processor/CPU 205 in executing its various software programs, while the nonvolatile memory or storage device 207 may comprise a hard drive or other mass storage device providing storage for programs not in use or for other data generated or used in the course of gaming machine operation. Network controller 210 provides an interface to other components of a gaming system in which gaming machine 100 is included.

It should be noted that the invention is not limited to gaming machines employing the arrangement of processing devices and interfaces shown in example gaming machine 100. Other gaming machines through which the features herein are implemented may include one or more special purpose processing devices to perform the various processing steps for implementing the present invention, such as generating random numbers or checking the security status of software packages or gaming credit vouchers. Unlike processing devices such as game processor/CPU 205, these special purpose processing devices may not employ operational program code to direct the various processing steps.

Still referring to the hardware and logical block diagram 200 showing an example design for a gaming machine 100, the depicted machine in operation is controlled generally by game processor/CPU 205 which stores operating programs and data in non-volatile memory or storage device 207 with game module 204, and software or drivers for user interface 220, network controller 210, audio/visual controllers, and a hardware random number generator (RNG) 213, which is employed if software RNG procedures are not allowed in a particular gaming jurisdiction. Either hardware RNG 213 or a suitable software RNG are employed for making the random selections of game outcomes, reel stop positions, etc. when operating the game as described herein. The game module 204, once installed, also is held in non-volatile memory of the EGM, preferably a separate flash drive or hard drive from the memory holding the EGM operating system. CPU or game processor/CPU 205 may comprise a conventional microprocessor, such as an Intel microprocessor, mounted on a printed circuit board with supporting ports, drivers, memory, software, and firmware to communicate with and control gaming machine operations, such as through the execution of coding stored in non-volatile memory or storage device 207 including one or primary game modules 204, including executable code and data structures such data structures for performing the primary game in the mode 230, and data structures for performing the primary game in the second gaming mode 232. Game processor/CPU 205 connects to user interface 220 such that a player may enter input information, and game processor/CPU 205 may respond according to its programming, such as to apply a wager and initiate execution of a game.

Game processor/CPU 205 also may connect through network controller 210 to a gaming network, such as example casino server network 400 shown in FIG. 12.

Referring now to FIG. 12, the casino server network 400 may be implemented over one or more site locations and include host server 401, and an EGM configuration server 406 (in the preferred version the Even Games Nitro Host server) for managing the configuration of multiple EGMs 100 on the network. A group display device 408 is coupled to casino server network 400 may include its own controller and graphics processor for driving the group display in response to commands received over a network connection. The network may also include remote game play server 403 (which may be configured to provide game processor functionality including determining game outcomes and providing audio/visual instructions to a remote gaming device), a group control server 404 (which controls the gaming mode of the group of gaming machines including determining when to change the gaming mode and controlling the meters in the second gaming mode), central determinant server 405 (which may be configured to determine lottery, bingo, or other centrally determined game outcomes and provide the information to networked gaming machines 100 providing lottery and bingo-based wagering games to patrons), progressive server 407 (which may be configured to accumulate a progressive pool from a portion of wagering proceeds or operator marketing funds and to award progressive awards upon the occurrence of a progressive award winning event to one or more networked gaming machines 100), player account server 409 (which may be configured to collect and store player information and/or awards and to provide player information to gaming machines 100 after receiving player identification information such as from a player card), and accounting server 411 (which may be configured to receive and store data from networked gaming machines 100 and to use the data to provide reports and analyses to an operator). Through its network connection, gaming machine 100 may be monitored by an operator through one or more servers such as to assure proper operation, and, data and information may be shared between gaming machine 100 and respective of the servers in the network such as to accumulate or provide player promotional value, to provide server-based games, or to pay server-based awards. While some of the servers have been shown separately, they may be combined or split into additional servers having additional capabilities.

As shown, networked electronic gaming machines 100 (EGM1-EGM4) and one or more overhead group displays 408 may be network connected and enable the content of one or more displays of gaming machines 100 to be mirrored or replayed on an overhead display. EGMs 100 may also feed celebration graphics directly to the overhead displays 408 in the course of providing games, for example to show a celebration for a large bonus win or group gaming mode win on a particular EGM 100. Typically the overhead display function and group celebration scenarios are managed by a floor messaging server such as Nitro floor messaging server 404, which receives messages from EGM's 100 to communicate group gaming mode wins, bonus game wins, or awards of other large prizes such as progressive prizes. The primary display content may also be stored by the display controller or game processor/CPU 205 and transmitted through network controller 210 to the overhead display controller either substantially simultaneously or at a subsequent time according to either periodic programming executed by game processor/CPU 205 or a triggering event, such as a jackpot or large win, at a respective gaming machine 100. In the event that gaming machines 100 have cameras installed, the respective player's video images may be displayed on overhead display 408 along with the content of the player's gaming machine 100 and any associated audio feed.

In one or more embodiments, game server 403 may provide server-based games and/or game services to network connected gaming devices, such as gaming machines 100 (which may be connected by network cable or wirelessly). Progressive server 407 may accumulate progressive awards by receiving defined amounts (such as a percentage of the wagers from eligible gaming devices or by receiving funding from marketing or casino funds) and provide progressive awards to winning gaming devices upon a progressive event, such as a progressive jackpot game outcome or other triggering event such as a random or pseudo-random win determination at a networked gaming device or server (such as to provide a large potential award to players playing the community feature game). Accounting server 411 may receive gaming data from each of the networked gaming devices, perform audit functions, and provide data for analysis programs, such as the IGT Mariposa program bundle.

Player account server 409 may maintain player account records, and store persistent player data such as accumulated player points and/or player preferences (e.g. game personalizing selections or options). For example, the player tracking display may be programmed to display a player menu that may include a choice of personalized gaming selections that may be applied to a gaming machine 100 being played by the player.

In one or more embodiments, the player menu may be programmed to display after a player inserts a player card into the card reader. When the card reader is inserted, an identification may be read from the card and transmitted to player account server 409. Player account server 409 transmits player information through network controller 210 to user interface 220 for display on the player tracking display. The player tracking display may provide a personalized welcome to the player, the player's current player points, and any additional personalized data. If the player has not previously made a selection, then this information may or may not be displayed. Once the player makes a personalizing selection, the information may be transmitted to game processor/CPU 205 for storing and use during the player's game play. Also, the player's selection may be transmitted to player account server 409 where it may be stored in association with the player's account for transmission to the player in future gaming sessions. The player may change selections at any time using the player tracking display (which may be touch sensitive or have player-selectable buttons associated with the various display selections).

In one or more embodiments, a gaming website may be accessible by players, e.g. gaming website 421, whereon one or more games may be displayed as described herein and played by a player such as through the use of personal computer 423 or handheld wireless device 425 (e.g. Apple iPhone, Android phone, tablet, phablet, virtual reality device, iPad, etc.). To enter the website, a player may log in with a username (that may be associated with the player's account information stored on player account server 409 or be accessible by a casino operator to obtain player data and provide promotional offers), play various games on the website, make various personalizing selections and save the information, so that during a next gaming session at a casino establishment, the player's playing data and personalized information may be associated with the player's account and accessible at the player's selected gaming machine 100.

Referring generally to the description herein, any use of ordinal terms such as “first,” “second,” “third,” etc., to refer to an element does not by itself connote any priority, precedence, or order of one element over another, or the temporal order in which acts of a method are performed. Rather, unless specifically stated otherwise, such ordinal terms are used merely as labels to distinguish one element having a certain name from another element having a same name (but for use of the ordinal term).

Further, as described herein, the various features have been provided in the context of various described embodiments, but may be used in other embodiments. The combinations of features described herein should not be interpreted to be limiting, and the features herein may be used in any working combination or sub-combination according to the invention. This description should therefore be interpreted as providing written support, under U.S. patent law and any relevant foreign patent laws, for any working combination or some sub-combination of the features herein.

The above-described embodiments are intended to illustrate the principles of the invention, but not to limit the scope of the invention. Various other embodiments and modifications to these example embodiments may be made by those skilled in the art without departing from the scope of the present invention.

1. A method for controlling the operation of a group of gaming machines linked on a network, the method including:
in response to a play input entered through a player input device of a respective one of the gaming machines and under control of a processing system of the respective gaming machine, causing a display system of the respective gaming machine to display a base result representation in a first area of the display system comprising a matrix of symbol locations in a first gaming mode;
in response to a mode change event received over the network, changing a mode of all gaming machines in the group to a second gaming mode including a meter displayed by the display system;
receiving play inputs in the second gaming mode, providing results therefore, and decreasing a level of the meter for each gaming machine in the group based on the time spent in the second gaming mode;
in response to a gaming result at the respective gaming machine including a bonus event trigger in the second gaming mode, activating a bonus outcome for the respective gaming machine including at least one bonus prize, and in response to the bonus outcome at the respective gaming machine, decreasing the level of the meter at each gaming machine in the group; and
ending the second game mode and returning to the first game mode for each gaming machine in the group when the meter reaches a defined lowest level.

2. The method of claim 1, wherein the mode change event is determined by a group control server based on randomly selecting a time to change the mode from the first mode to the second mode.

3. The method of claim 1, wherein:
decreasing a level of the meter for each gaming machine in the group based on the time spent in the second gaming mode is done continuously at a designated rate over the time spent in the second game mode; and
wherein decreasing the level of the meter at each gaming machine in the group in response to the bonus outcome at the respective gaming machine further comprises reducing the meter at a higher rate than the designated rate over a period during which the bonus outcome is presented at the respective gaming machine.

4. The method of claim 3, wherein the designated rate is a rate that depletes the meter to the defined lowest level over more than five minutes, and wherein decreasing the level of the meter at each gaming machine in the group in response to the bonus outcome at the respective gaming machine further comprises decreasing the meter by at least 10% in the period during which the bonus outcome is presented.

5. The method of claim 3, further comprising adjusting at least one of the designated rate or the higher rate depending on a number of players active on the group of gaming machines.

6. The method of claim 1, in which the bonus outcome provides the at least one bonus prize only for the respective gaming machine, and in which the second gaming mode further comprises:
in response to a gaming result at a second respective gaming machine of the group of gaming machines including a bonus event trigger, activating a bonus outcome for the second respective gaming machine including at least one bonus prize, and in response to the bonus outcome at the second respective gaming machine, decreasing the level of the meter at each gaming machine in the group.

7. A gaming system comprising:
a group of gaming machines operable to communicate over a network, each gaming machine comprising:
a display system, an audio device, a player input device, and at least one electronic controller operatively coupled to the display system, the audio device, and the player input device and configured to execute instructions related to a game; and
tangible, non-transitory electronically accessible memory coupled to the at least one electronic controller and containing program code executable by the at least one electronic controller for:
in response to a play input entered through the player input device causing the display system to display a base result representation in a first area of the display system comprising a matrix of symbol locations in a first gaming mode;
in response to a mode change event received over the network, changing the mode of the gaming machine to a second gaming mode including a meter displayed by the display system and a different paytable for the game than that of the first gaming mode;
receiving play inputs in the second gaming mode, providing results therefore, and decreasing a level of the meter based on the time spent in the second gaming mode;
in response to a gaming result at the gaming machine including a bonus event trigger in the second gaming mode, activating a bonus outcome for the gaming machine including at least one bonus prize, and in response to the bonus outcome at the gaming machine, decreasing the level of the meter; and
a group control server adapted to communicate with the group of gaming machines over the network and operable to, in response to the bonus outcome at the gaming machine, cause the level of the meter to be decreased at each gaming machine in the group, and to cause the group of gaming machines to end the second game mode and returning to the first game mode when the meter reaches a defined lowest level.

8. The system of claim 7, wherein group control server is further operable controlling the change of mode from the first gaming mode to the second gaming mode based on randomly selecting a time to change the mode from the first mode to the second mode.

9. The system of claim 7, wherein:
decreasing a level of the meter for each gaming machine in the group based on the time spent in the second gaming mode is done continuously at a designated rate over the time spent in the second game mode; and
wherein decreasing the level of the meter at each gaming machine in the group in response to the bonus outcome at the respective gaming machine further comprises reducing the meter at a higher rate than the designated rate over a period during which the bonus outcome is presented at the respective gaming machine.

10. The system of claim 9, wherein the designated rate is a rate that depletes the meter to the defined lowest level over more than five minutes, and wherein decreasing the level of the meter at each gaming machine in the group in response to the bonus outcome at the respective gaming machine further comprises decreasing the meter by at least 10% in the period during which the bonus outcome is presented.

11. The system of claim 9, wherein the program code is further executable for adjusting at least one of the designated rate or the higher rate depending on a number of players active on the group of gaming machines.

12. The system of claim 7, in which the bonus outcome provides the at least one bonus prize only for the respective gaming machine on which it is triggered, and in which the second gaming mode further comprises:
in response to a gaming result at a second respective gaming machine of the group of gaming machines including a bonus event trigger, activating a bonus outcome for the second respective gaming machine including at least one bonus prize, and in response to the bonus outcome at the second respective gaming machine, decreasing the level of the meter at each gaming machine in the group.

13. Tangible, non-transitory computer readable media holding a program product for execution by a controllers of a gaming system including a group of gaming machines and a group control server coupled to the gaming machines over a network, the program product including machine instruction program code for:
in response to a play input entered through a player input device of a respective one of the gaming machines and under control of a processing system of the respective gaming machine, causing a display system of the respective gaming machine to display a base result representation in a first area of the display system comprising a matrix of symbol locations in a first gaming mode;
in response to a mode change event received over the network, changing a mode of all gaming machines in the group to a second gaming mode including a meter displayed by the display system and a different paytable for the game than that of the first gaming mode;
receiving play inputs in the second gaming mode, providing results therefore, and decreasing a level of the meter for each gaming machine in the group based on the time spent in the second gaming mode;
in response to a gaming result at the respective gaming machine including a bonus event trigger in the second gaming mode, activating a bonus outcome for the respective gaming machine including at least one bonus prize, and in response to the bonus outcome at the respective gaming machine, decreasing the level of the meter at each gaming machine in the group; and
ending the second game mode and returning to the first game mode for each gaming machine in the group when the meter reaches a defined lowest level.

14. The tangible, non-transitory computer readable media of claim 13, wherein the mode change event is determined by the group control server based on randomly selecting a time to change the mode from the first mode to the second mode.

15. The tangible, non-transitory computer readable media of claim 13, wherein:
decreasing a level of the meter for each gaming machine in the group based on the time spent in the second gaming mode is done continuously at a designated rate over the time spent in the second game mode; and
wherein decreasing the level of the meter at each gaming machine in the group in response to the bonus outcome at the respective gaming machine further comprises reducing the meter at a higher rate than the designated rate over a period during which the bonus outcome is presented at the respective gaming machine.

16. The tangible, non-transitory computer readable media of claim 15, wherein the designated rate is a rate that depletes the meter to the defined lowest level over more than five minutes, and wherein decreasing the level of the meter at each gaming machine in the group in response to the bonus outcome at the respective gaming machine further comprises decreasing the meter by at least 10% in the period during which the bonus outcome is presented.

17. The tangible, non-transitory computer readable media of claim 15, wherein the meter includes a graphic presentation of a fuel gauge, and wherein decreasing the level of the meter at each gaming machine in the group in response to the bonus outcome at the respective gaming machine further comprises multiple phases each presenting a graphical sequence depicting fuel being burned in a graphic presentation of the bonus outcome, each phase with an associated depletion of the fuel gauge.

18. The tangible, non-transitory computer readable media of claim 15, in which the bonus outcome provides the at least one bonus prize only for the respective gaming machine, and in which the second gaming mode further comprises:
in response to a gaming result at a second respective gaming machine of the group of gaming machines including a bonus event trigger, activating a bonus outcome for the second respective gaming machine including at least one bonus prize, and in response to the bonus outcome at the second respective gaming machine, decreasing the level of the meter at each gaming machine in the group.
